(19) United States
(12) Patent Application Publication
(10) Pub. No.: US 2025/0290441 A1
(43) Pub. Date: Sep. 18, 2025

(54) AIR COMPRESSOR, INTERNAL COMBUSTION ENGINE ASSEMBLY, AND VEHICLE

(71) Applicant: Isuzu Motors Limited, Yokohama-shi (JP)

(72) Inventor: Masao SATO, Fujisawa-shi (JP)

(73) Assignee: Isuzu Motors Limited, Yokohama-shi (JP)

(21) Appl. No.: 19/041,430

(22) Filed: Jan. 30, 2025

(30) Foreign Application Priority Data
Mar. 15, 2024 (JP) 2024-041592

(51) Int. Cl. F02B 65/00

(52) U.S. Cl. CPC F02B 65/00

(57) ABSTRACT

An air compressor includes: a cylinder block including a crankcase and a cylinder portion of a plurality of cylinders; a cylinder head that covers the cylinder block; a crankshaft that is supported in the crankcase; a piston that is configured to reciprocate in the cylinder portion by the crankshaft to suck air and compress and discharge the sucked air; and a first rib that is provided on an outer wall of the cylinder block, that extends in a direction along a direction in which the piston reciprocates, that protrudes in a direction orthogonal to the direction in which the piston reciprocates, and that is configured to suppress vibration of the cylinder block.

### CROSS REFERENCE TO RELATED APPLICATIONS

This application is based upon and claims the benefit of priority from prior Japanese Patent Application No. 2024-041592, filed Mar. 15, 2024, the entire contents of which are incorporated herein by reference.

### FIELD

The present invention relates to an air compressor, an internal combustion engine assembly, and a vehicle.

### BACKGROUND

An air compressor is driven in conjunction with an internal combustion engine in order to store, in an air tank, compressed air used for an air brake of a vehicle, for example. For example, as disclosed in Jpn. Pat. Appln. KOKAI Publication No. 2008-274840, a conventional air compressor is a single cylinder.

### SUMMARY

According to an aspect of the present invention, there is provided an air compressor including: a cylinder block including a crankcase and a cylinder portion of a plurality of cylinders; a cylinder head that covers the cylinder block; a crankshaft that is supported in the crankcase; a piston that is configured to reciprocate in the cylinder portion by the crankshaft to suck air and compress and discharge the sucked air; and a first rib that is provided on an outer wall of the cylinder block, that extends in a direction along a direction in which the piston reciprocates, that protrudes in a direction orthogonal to the direction in which the piston reciprocates, and that is configured to suppress vibration of the cylinder block.

### BRIEF DESCRIPTION OF THE DRAWINGS

FIG. 1 is a schematic diagram illustrating a vehicle including an internal combustion engine assembly including an air compressor according to an embodiment and an internal combustion engine serving as a power source for driving the air compressor.

FIG. 2 is a schematic view illustrating a positional relationship between the internal combustion engine and the air compressor, and illustrating an arrangement of a power gear (crankshaft sprocket) of the internal combustion engine, a driven gear fixed to a crankshaft of the air compressor, and an idle gear between the power gear and the driven gear.

FIG. 3 is a schematic view illustrating the air compressor according to the embodiment.

FIG. 4 is a schematic view illustrating the crankshaft disposed in a crankcase of the air compressor according to the embodiment.

FIG. 5 is a schematic view illustrating a cylinder block of the air compressor according to the embodiment.

FIG. 6 is a schematic view illustrating a rib provided in the cylinder block of the air compressor according to the embodiment and a comparative example of the rib.

FIG. 7 is a schematic view illustrating a state in which the air compressor according to the embodiment is attached to the internal combustion engine.

FIG. 8 is a graph illustrating an analysis result (a horizontal axis: frequency (Hz) and a vertical axis: acceleration (m/s²)) in a case where vibration is applied to the air compressor in an up-down direction.

FIG. 9A is a view illustrating an example of movement of the air compressor in a case where an input frequency to the air compressor in the up-down direction is left: 575 Hz and right: 585 Hz.

FIG. 9B is a view illustrating an example of movement of the air compressor in a case where the input frequency to the air compressor in the up-down direction is left: 2178 Hz and right: 2048 Hz.

FIG. 9C is a view illustrating an example of movement of the air compressor in a case where the input frequency to the air compressor in the up-down direction is left: 2704 Hz and right: 2557 Hz.

FIG. 10 is a graph illustrating an analysis result (the horizontal axis: frequency (Hz) and the vertical axis: acceleration (m/s²)) in a case where vibration is applied to the air compressor in a right-left direction.

FIG. 11A is a view illustrating an example of movement of the air compressor in a case where the input frequencies to the air compressor in the right-left direction are the left: 406 Hz and the right: 394 Hz.

FIG. 11B is a view illustrating an example of movement of the air compressor in a case where the input frequencies to the air compressor in the right-left direction are the left: 1906 Hz and the right: 1784 Hz.

FIG. 11C is a view illustrating an example of movement of the air compressor in a case where the input frequencies to the air compressor in the right-left direction are the left: 2178 Hz and the right: 2048 Hz.

### DETAILED DESCRIPTION

Hereinafter, an air compressor 22 of an internal combustion engine assembly 12 of a vehicle 10 according to the present embodiment will be described with reference to the drawings. A relative size of each member in each drawing is schematic, and may be different from an actual size.

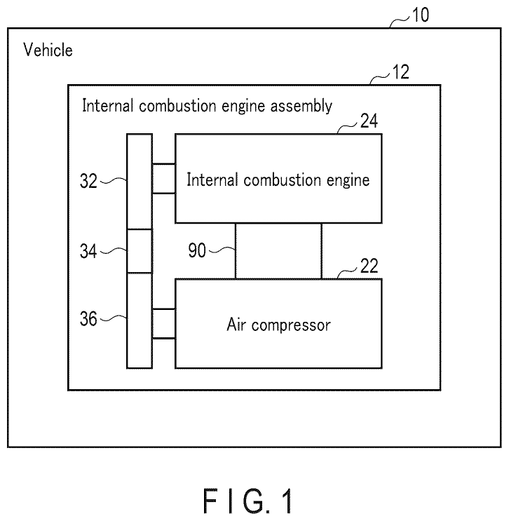

As illustrated in FIG. 1, the vehicle 10 includes the internal combustion engine assembly 12 having the air compressor 22 and an internal combustion engine 24 serving as a power source configured to drive the air compressor 22. An example of the vehicle 10 is a truck, a tractor, or the like.

The internal combustion engine 24 is, for example, a diesel engine or the like.

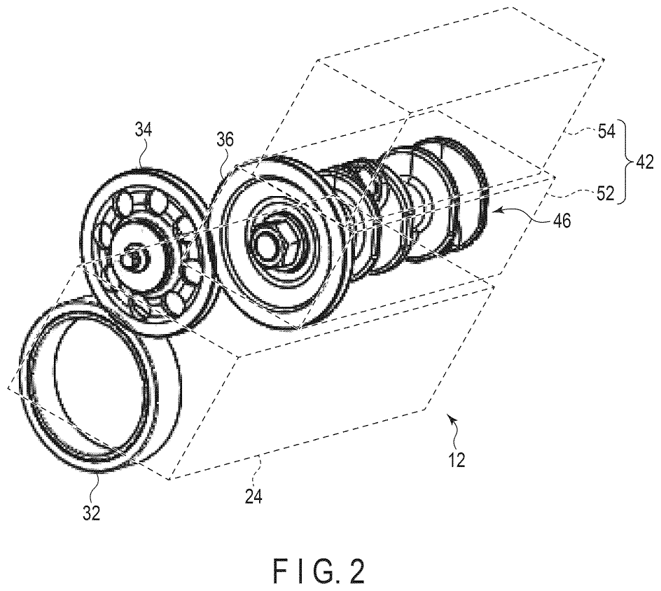

As illustrated in FIG. 2, a driven gear 36 to which a crankshaft 46 of the air compressor 22 is fixed is disposed on a power gear 32 such as a crankshaft sprocket of the internal combustion engine 24 via an idle gear 34. The idle gear 34 is used as an intermediate gear between the power gear 32 and the driven gear 36. The driven gear 36 has the idle gear 34 disposed between the driven gear 36 and the power gear 32, and is rotated by receiving a rotational force of the power gear 32 via the idle gear 34.

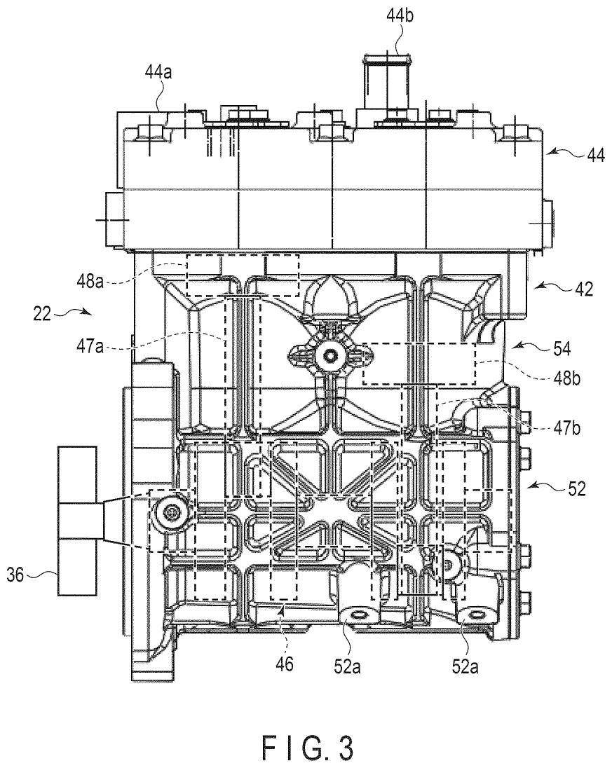

The air compressor 22 illustrated in FIG. 3 will be described as two cylinders (two piston chambers) in the present embodiment, but may be more multi-cylinders such as three or more cylinders (piston chambers).

The air compressor 22 includes a cylinder block 42 that includes a crankcase 52 and a cylinder portion 54 of a plurality of cylinders, a cylinder head 44 that covers the cylinder portion 54 of the cylinder block 42, a crankshaft 46 that is supported in the crankcase 52, and pistons 48a and 48b that is configured to reciprocate in the cylinder portion 54 by the crankshaft 46, take in air from an outside of the air compressor 22, compress the taken air, and discharge the compressed air to the outside of the air compressor 22.

The cylinder block 42 and the cylinder head 44 are each formed of, for example, cast iron.

The cylinder head 44 is provided with an air suction port 44a and an air discharge port 44b. The air suction port 44a is formed as an opening for taking in air into the air compressor 22. An air tank (not illustrated) is connected to the air discharge port 44b. Compressed air compressed using the pistons 48a and 48b in the air compressor 22 is discharged through the air discharge port 44b and stored in the air tank.

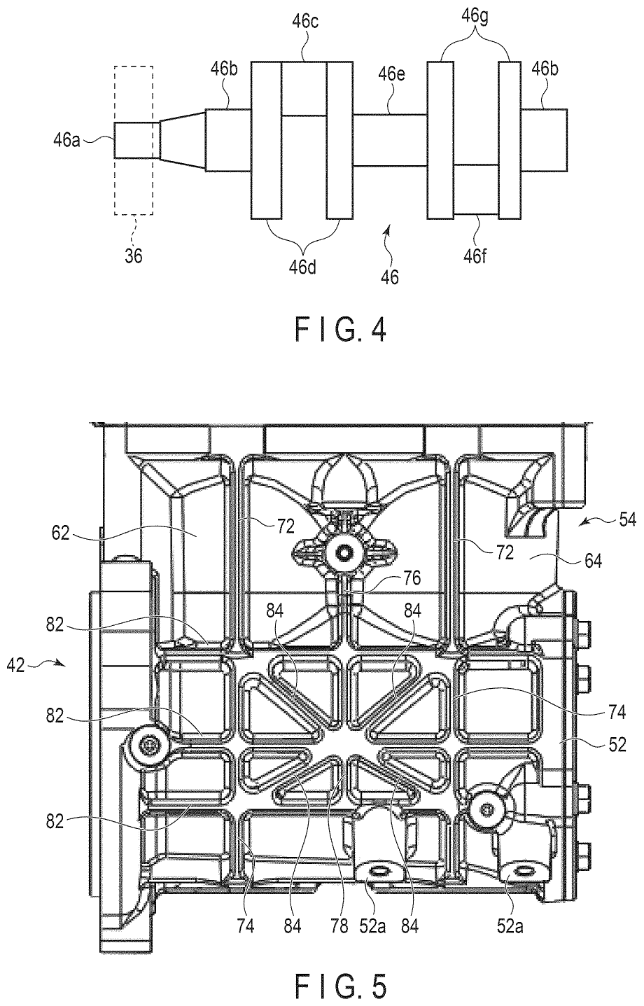

In the present embodiment, the crankshaft 46 illustrated in FIG. 4 is used.

The crankshaft 46 includes a main shaft 46a, a main journal 46b, a first crank pin 46c, first counterweights 46d, a coupling portion 46e, a second crank pin 46f, and second counterweights 46g.

The first crank pin 46c is disposed between the first counterweights 46d. A central axis of the first crank pin 46c is shifted from a central axis of the main shaft 46a and the main journal 46b. The first crank pin 46c is coupled to one end of a first connecting rod 47a (see FIG. 3).

The second crank pin 46f is disposed between the second counterweights 46g. A central axis of the second crank pin 46f is shifted from the central axis of the main shaft 46a and the main journal 46b. The second crank pin 46f is coupled to one end of a second connecting rod 47b (see FIG. 3).

The central axis of the first crank pin 46c and the central axis of the second crank pin 46f are shifted by, for example, 180° with respect to the central axis of the main shaft 46a and the main journal 46b.

In the present embodiment, a central axis of the coupling portion 46e coincides with the central axis of the main shaft 46a and the main journal 46b.

FIG. 5 illustrates the cylinder block 42.

The crankcase 52 illustrated in FIG. 5 is formed in a substantially cylindrical shape in order to rotate the crankshaft 46 about the central axis of the main shaft 46a and the main journal 46b in the crankcase 52.

The cylinder portion 54 is provided so as to protrude in a radial direction with respect to the crankcase 52. In the cylinder portion 54, a first cylinder portion 62 and a second cylinder portion 64 are arranged along an axial direction of the crankshaft 46. An axial direction of the first cylinder portion 62 and an axial direction of the second cylinder portion 64 intersect with the axial direction of the crankshaft 46. It is preferably that the axial directions of the first cylinder portion 62 and the second cylinder portion 64 are parallel.

As illustrated in FIG. 3, the first piston 48a is disposed in the first cylinder portion 62, and the first connecting rod 47a is disposed between the crankshaft 46 and the first piston 48a. The second piston 48b is disposed in the second cylinder portion 64, and the second connecting rod 47b is disposed between the crankshaft 46 and the second piston 48b. Note that the first piston 48a and the second piston 48b are favorably formed in a bottomed cylindrical shape, for example, and a bottom side is disposed on a side of the cylinder head 44.

As illustrated in FIG. 5, the air compressor 22 includes first-first ribs (first ribs) 72 that are provided on an outer wall of the cylinder block 42, and that are configured to suppress vibration of the cylinder block 42. The first-first ribs 72 are favorably provided on an outer peripheral surface of the first cylinder portion 62 and an outer peripheral surface of the second cylinder portion 64. The first-first ribs 72 respectively extend along the axial directions of the first cylinder portion 62 and the second cylinder portion 64 in which the first piston 48a and the second piston 48b (see FIG. 3) reciprocate, and protrude in a direction orthogonal to the direction in which the pistons 48a and 48b reciprocate. The first-first ribs 72 favorably extend straight.

The air compressor 22 includes first-second ribs (third ribs) 74 that are provided on an outer wall of the crankcase 52, and that is continuous to the first-first ribs 72. The first-second ribs 74 protrude outward in the radial direction from an outer peripheral surface of the cylindrical crankcase 52.

Further, the air compressor 22 includes a first-third rib (first rib) 76 that is provided near a boundary between the first cylinder portion 62 and the second cylinder portion 64, and that is parallel to the first-first ribs 72.

The air compressor 22 includes a first-fourth rib (third rib) 78 that is provided on the outer wall of the crankcase 52, and that is continuous to the first-third rib 76.

The air compressor 22 includes second ribs 82 that are provided on the outer wall of the crankcase 52, that protrudes in the radial direction from the central axis of the crankshaft 46 and that is configured to suppress vibration of the crankcase 52. The air compressor 22 includes inclined ribs (fourth ribs) 84 that are provided on the outer wall of the crankcase 52, and that intersect with the second ribs 82 and the first-second ribs 74.

Note that it is favorable that, although not illustrated, the air compressor 22 includes the ribs 72, 74, 76, 78, 82, and 84 that are similarly provided on an opposite surface of the cylinder block 42 to the side illustrated in FIGS. 3 and 5.

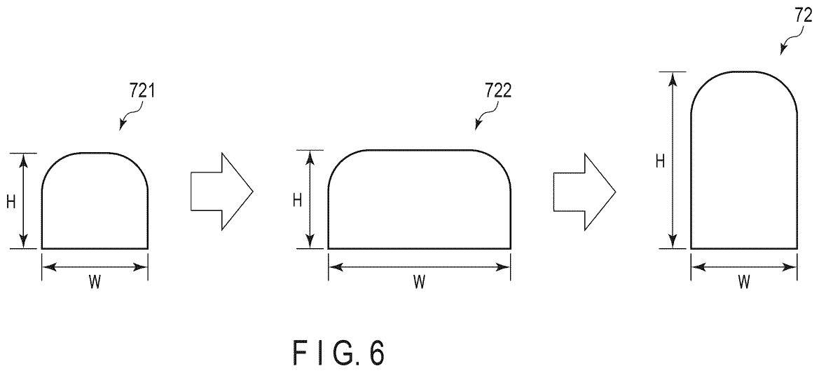

The right view of FIG. 6 illustrates a cross-sectional view of the rib 72. The left view of FIG. 6 and the middle view of FIG. 6 are comparative examples of the rib 72. The rib in the left view of FIG. 6 is denoted by reference numeral 721, and the rib in the middle view of FIG. 6 is denoted by reference numeral 722.

Lower sides of the ribs 72, 721, and 722 in FIG. 6 are assumed to be integrally molded with the cylinder block 42. Among section moduli of the ribs 72, 721, and 722 in FIG. 6, the section modulus of the middle rib 722 is larger than that of the left rib 721 in FIG. 6, and the section modulus of the rib 72 according to the present embodiment on the right is larger than that of the middle rib 722. Therefore, a right-side rib among the ribs 72, 721, and 722 illustrated in FIG. 6 has higher rigidity. Therefore, in the present embodiment, it is favorable to use the cross section in the right-side view of FIG. 6 in which a height H of each of the ribs 72, 74, 76, 78, 82, and 84 is larger than a width W of each of the ribs 72, 74, 76, 78, 82, and 84. A ratio H/W of the height H to the width W of each of the ribs 72, 74, 76, 78, 82, and 84 is favorably larger than 1.

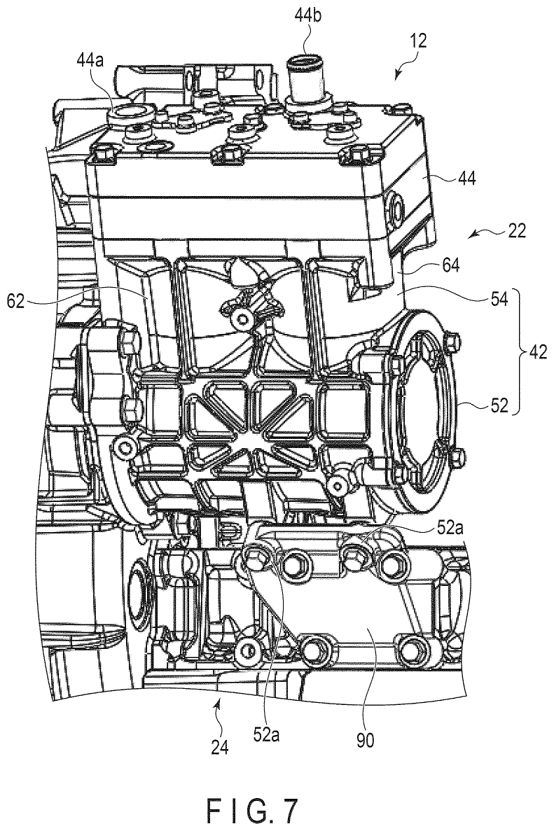

As illustrated in FIG. 7, the internal combustion engine assembly 12 has a block-shaped bracket 90 formed of cast iron that fixes the outer peripheral surface of the crankcase 52 of the air compressor 22 to the internal combustion engine 24, for example. The bracket 90 is favorably fixed to a lower fixing portion 52a of the outer peripheral surface of the crankcase 52 of the air compressor 22. By fixing the air compressor 22 on a virtual plane stretched by the central axes of the pistons 48a and 48b or a position near the virtual plane, the cylinder block 42 including the crankcase 52 can suppress generation of a moment of inertia.

Vibration analysis results in a case where vibration is applied to such an air compressor 22 at an appropriate frequency in a direction along the direction (up-down direction) in which the pistons 48a and 48b move and in a case where vibration is applied to the air compressor in the right-left direction orthogonal to the up-down direction in which the pistons 48a and 48b move are illustrated. The right-left direction referred to here is a direction orthogonal to the virtual plane stretched by the two central axes defined by the two pistons 48a and 48b.

Specifically, the driving force from the power gear 32 of the internal combustion engine 24 rotates the crankshaft 46 via the idle gear 34 and the driven gear 36. Then, as the crankshaft 46 rotates, the first connecting rod 47a moves the first piston 48a up and down in the first cylinder portion 62, and the second connecting rod 47b moves the second piston 48b up and down in the second cylinder portion 64. In such a state, the air compressor 22 tends to vibrate in the up-down direction and also tends to vibrate in the right-left direction.

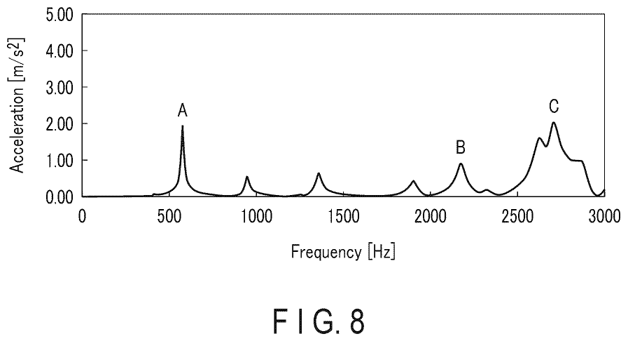

FIG. 8 illustrates the analysis result in the case where vibration is applied in the up-down direction to the air compressor 22. The horizontal axis represents the frequency (Hz), and the vertical axis represents acceleration (m/s²). At this time, an input frequency to the air compressor 22 has peaks around 500 to 600 Hz, around 2000 to 2300 Hz, and around 2500 to 2800 Hz.

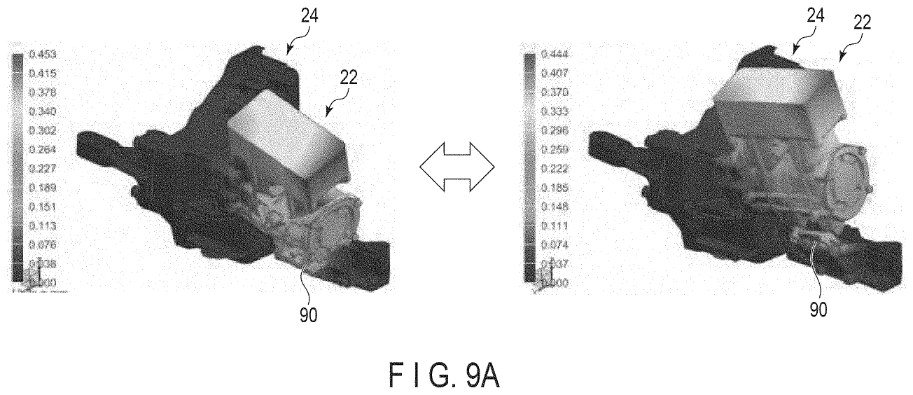

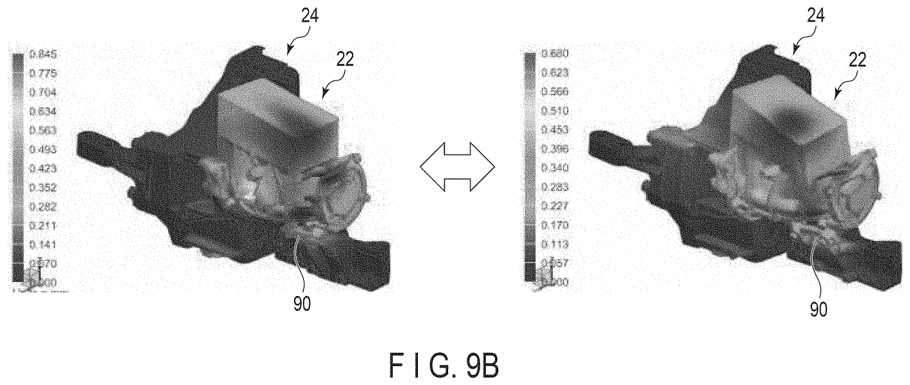

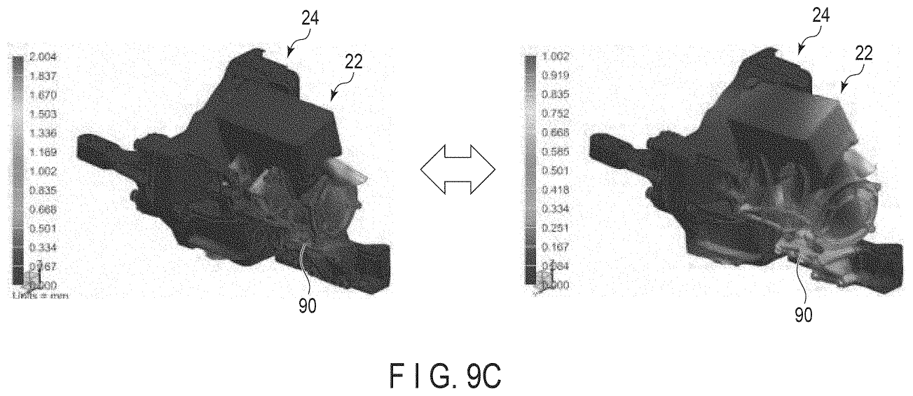

FIGS. 9A to 9C illustrate analysis results of vibration response analysis (movement at each peak) of the air compressor 22 in the up-down direction. Colors in each of FIGS. 9A to 9C indicate relative displacement in each of the drawings. That is, for example, there is no correlation between the colors of the drawing illustrated in FIG. 9A and the drawing illustrated in FIG. 9B.

FIG. 9A illustrates an example of movement of the air compressor 22 in a case where the input frequency to the air compressor 22 is 500 Hz or higher. As an example, an example at 575 Hz on the left and 585 Hz on the right is illustrated. Deformation is observed in some places, but the maximum displacement of the air compressor 22 is suppressed to be low within 0.5 mm.

FIG. 9B illustrates an example of movement of the air compressor 22 in a case where the input frequency to the air compressor 22 is 2000 Hz or higher. As an example, an example at 2178 Hz on the left and 2048 Hz on the right is illustrated. Deformation is observed in some places, but the maximum displacement of the air compressor 22 is suppressed to be low within 0.9 mm.

FIG. 9C illustrates an example of movement of the air compressor 22 in a case where the input frequency to the air compressor 22 is 2500 Hz or higher. As an example, an example at 2704 Hz on the left and 2557 Hz on the right is illustrated. Deformation is observed in some places, but the maximum displacement of the air compressor 22 is suppressed to be low within 2 mm.

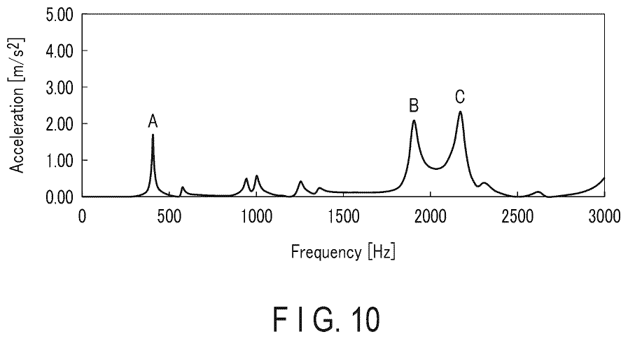

FIG. 10 illustrates the analysis result in the case where vibration is applied in the right-left direction to the air compressor 22. The horizontal axis represents the frequency (Hz), and the vertical axis represents acceleration (m/s²). At this time, the input frequency to the air compressor 22 has peaks around 350 to 450 Hz (up to 500 Hz), around 1800 to 2000 Hz (up to 2000 Hz), and around 2000 to 2250 Hz (2000 Hz or higher).

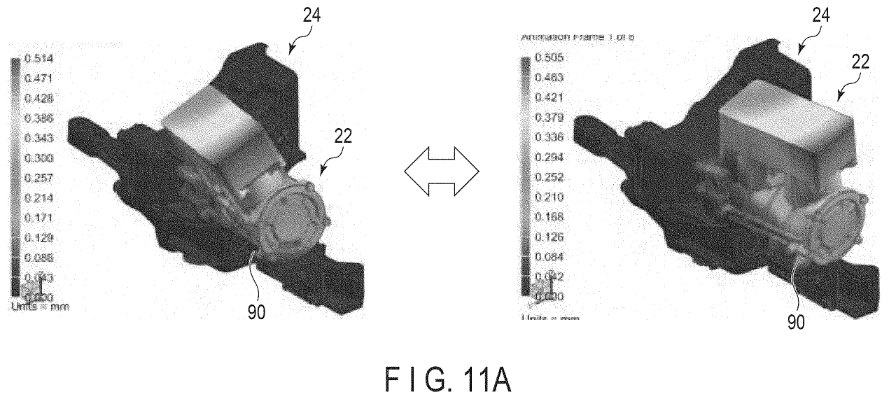

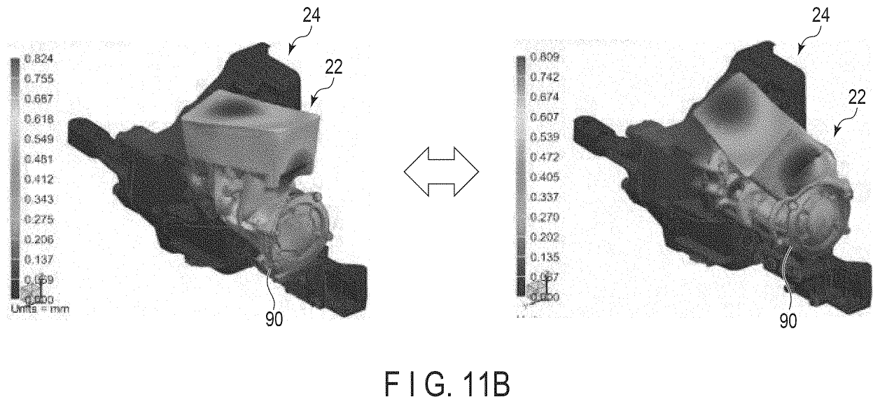

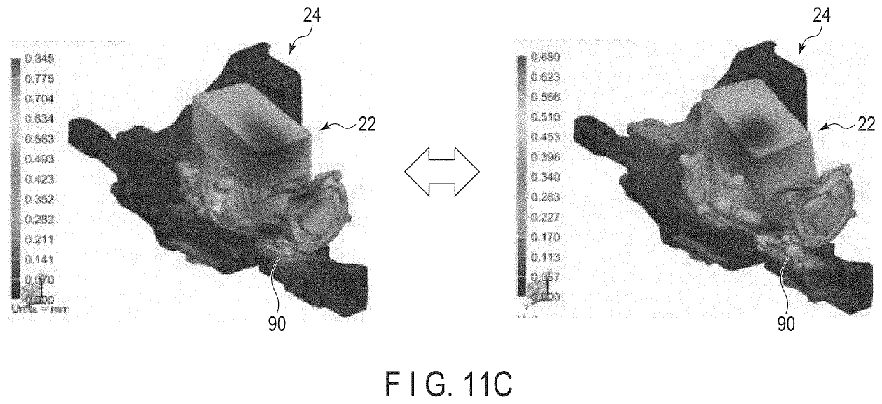

FIGS. 11A to 11C illustrate analysis results of vibration response analysis (movement at each peak) of the air compressor 22 in the right-left direction.

FIG. 11A illustrates an example of movement of the air compressor 22 in a case where the input frequency to the air compressor 22 is up to 500 Hz. As an example, an example at 406 Hz on the left and 394 Hz on the right is illustrated. Deformation is observed in some places, but the maximum displacement of the air compressor 22 is suppressed to be low about 0.5 mm.

FIG. 11B illustrates an example of movement of the air compressor 22 in a case where the input frequency to the air compressor 22 is up to 2000 Hz. As an example, an example at 1906 Hz on the left and 1784 Hz on the right is illustrated. Deformation is observed in some places, but the maximum displacement of the air compressor 22 is suppressed to be low about 0.8 mm.

FIG. 11C illustrates an example of movement of the air compressor 22 in a case where the input frequency to the air compressor 22 is 2000 Hz or higher. As an example, an example at 2178 Hz on the left and 2048 Hz on the right is illustrated. Deformation is observed in some places, but the maximum displacement of the air compressor 22 is suppressed to be low about 0.9 mm.

Therefore, in both of the vibration analysis results of the air compressor 22 illustrated in FIGS. 8 and 10, the maximum displacement was suppressed to be low.

From the analyses and the results of the actual machine of the air compressor 22, if the pistons 48a and 48b perform the up-down movement, the case (the cylinder block 42 and the cylinder head 44) of the air compressor 22 moves to a front side and a depth side in FIG. 3. Therefore, it is assumed that the presence of the first-first ribs 72, the first-second ribs 74, the first-third rib 76, and the first-fourth rib 78 illustrated in FIG. 5 exhibits a large effect by suppressing the vibration. Among them, the presence of the first ribs (the first-first ribs 72 and the first-third ribs 76) provided outside the first cylinder portion 62 and the second cylinder portion 64 that receive the up-down movement of the pistons 48a and 48b exhibits a large effect by suppressing the vibration.

If the crankshaft 46 of the air compressor 22 swings, the case (the cylinder block 42 and the cylinder head 44) of the air compressor 22 moves to the front side and the depth side and in the up-down direction in FIG. 3. Therefore, it is assumed that the presence of the first-first ribs 72, the first-second ribs 74, the first-third rib 76, the first-fourth rib 78, and the second ribs 82 illustrated in FIG. 5 exhibits a large effect by suppressing the vibration.

Further, if the crankshaft 46 of the air compressor 22 swings and the pistons 48a and 48b perform the up-down movement, it is assumed that not only the presence of the first-first ribs 72, the first-second ribs 74, the first-third rib 76, the first-fourth rib 78, and the second ribs 82 illustrated in FIG. 5 but also the inclined ribs 84 suppresses twist of the crankcase 52 and exhibits a large effect by suppressing the vibration.

In the present embodiment, the example in which the air compressor 22 has two cylinders has been described. However, even if the number of cylinders is three or more, it is possible to suppress an increase in vibration, that is, noise, by forming ribs similar to the ribs described above or by appropriately forming ribs having higher rigidity on the outer peripheral surface of the cylinder block 42.

According to the present embodiment, it is possible to provide the air compressor 22, the internal combustion engine assembly 12 including the air compressor 22, and the vehicle 10 including the internal combustion engine assembly 12 capable of suppressing an increase in vibration, that is, noise even by increasing the number of cylinders.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An air compressor comprising:
a cylinder block including a crankcase and a cylinder portion of a plurality of cylinders;
a cylinder head that covers the cylinder block;
a crankshaft that is supported in the crankcase;
a piston that is configured to reciprocate in the cylinder portion by the crankshaft to suck air and compress and discharge the sucked air; and
a first rib that is provided on an outer wall of the cylinder block, that extends in a direction along a direction in which the piston reciprocates, that protrudes in a direction orthogonal to the direction in which the piston reciprocates, and that is configured to suppress vibration of the cylinder block.

2. The air compressor according to claim 1, wherein
a height of the first rib is larger than a width of the first rib.

3. The air compressor according to claim 1, further comprising:
a second rib that is provided on an outer wall of the crankcase, that protrudes in a radial direction from a central axis of the crankshaft and that is configured to suppress vibration of the crankcase.

4. The air compressor according to claim 3, wherein
a height of the second rib is larger than a width of the second rib.

5. The air compressor according to claim 1, further comprising:
a third rib that is provided on an outer wall of the crankcase, and that is continuous with the first rib.

6. The air compressor according to claim 5, wherein
a height of the third rib is larger than a width of the third rib.

7. The air compressor according to claim 1, further comprising:
a second rib that is provided on an outer wall of the crankcase, that protrudes in a radial direction from a central axis of the crankshaft and that is configured to suppress vibration of the crankcase,
a third rib that is provided on the outer wall of the crankcase, and that is continuous with the first rib, and
a fourth rib that is provided on the outer wall of the crankcase, and that intersects with the second rib and the third rib.

8. An internal combustion engine assembly comprising:
the air compressor according to claim 1;
an internal combustion engine; and
a block-shaped bracket that fixes an outer peripheral surface of the crankcase of the air compressor to the internal combustion engine.

9. A vehicle comprising: the internal combustion engine assembly according to claim 8.
